(19) United States
(12) Patent Application Publication
(10) Pub. No.: US 2008/0176100 A1
(43) Pub. Date: Jul. 24, 2008

(54) EVAPORATING DEVICE, EVAPORATING METHOD, METHOD OF MANUFACTURING DISPLAY DEVICE, ORGANIC ELECTROLUMINESCENT ELEMENT, AND DISPLAY DEVICE

(75) Inventors: Naoki Uetake, Kanagawa (JP); Hiroshi Kano, Kanagawa (JP); Akira Saito, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/013,862

(22) Filed: Jan. 14, 2008

(30) Foreign Application Priority Data
Jan. 22, 2007 (JP) 2007-011141

(51) Int. Cl. B32B 9/00; C09K 11/00; B05D 5/12

(52) U.S. Cl. 428/690; 427/66; 159/2.1; 159/49

(57) ABSTRACT

An evaporating device including: a material retaining part for being filled with an evaporating material and heating the evaporating material; an opening for dispersing the evaporating material vaporized from the material retaining part toward an evaporated member; and a high-temperature body disposed between the material retaining part and the opening, the high-temperature body being heated to a temperature higher than a temperature of the evaporating material heated in the material retaining part.

### CROSS REFERENCES TO RELATED APPLICATIONS

The present application claims priority to Japanese Patent Application JP 2007-011141 filed in the Japan Patent Office on Jan. 22, 2007, the entire contents of which is being incorporated herein by reference.

### BACKGROUND

The present application relates to an evaporating device that performs evaporation by heating an evaporating material, thereby vaporizing the evaporating material, and dispersing the vaporized evaporating material from openings to an evaporated member, an evaporating method, an organic electroluminescent element, and a display device, and particularly to an evaporating device suitable when an organic material is used as the evaporating material, an evaporating method, an organic electroluminescent element, and a display device.

In a mass-production apparatus for forming an organic EL (electroluminescence) layer by evaporation, an evaporation source needs to be filled with a large amount of organic material so that production is performed continuously for a long period of time. Because the organic material is generally susceptible to heat, continuing heating the large amount of organic material to a temperature for achieving a fixed evaporation rate from a start to an end of a production time degrades the material and the characteristics of an organic EL element in a last stage of the production. In order to avoid this, a technique of directly pressing a heating element to a material has been proposed as a method of locally heating the material (see Patent Document 1 (Japanese Patent Laid-Open No. 2003-113465)).

In addition, Patent Document 2 (Japanese Patent Laid-Open No. 2003-253430) is cited as a technique of using heating by radiant heat rather than directly pressing a heating element to a material. There is another technique of vaporizing a material by only light, as disclosed in Patent Document 3 (Japanese Patent Laid-Open No. 2005-307302), for example.

However, with the technique of directly pressing a heating element to a material as disclosed in Patent Document 1, it is difficult to obtain a stable evaporation rate because of problems of heat conduction, convection due to melting, and the like of the organic material itself. With the technique of using heating by radiant heat as disclosed in Patent Document 2, the whole of a material is uniformly at a high temperature, and thus an effect of suppressing degradation of the material is not obtained. With the technique of vaporizing a material by only light as disclosed in Patent Document 3, it is difficult to obtain a stable rate as in the above-described local heating, and a high-energy laser light or the like is required to heat the material to a temperature for obtaining a desired evaporation rate by only light, so that a problem of destroying the organic material instead occurs.

### SUMMARY

According to an embodiment, there is provided an evaporating device including: a material retaining part for being filled with an evaporating material and heating the evaporating material; an opening for dispersing the evaporating material vaporized from the material retaining part toward an evaporated member; and a high-temperature body disposed between the material retaining part and the opening, the high-temperature body being heated to a temperature higher than a temperature of the evaporating material heated in the material retaining part.

According to an embodiment, only the surface of the material retaining part and the material filled in the material retaining part can be locally heated by radiant heat from the high-temperature body heated to the temperature higher than that of the material retaining part and the material at the time of evaporation. Thus a desired evaporation rate can be obtained without producing an effect of heating on the inside of the evaporating material.

A stable material that does not decompose or emit gas, for example, as a result of being heated in a vacuum, such as a metallic material (for example titanium (Ti), tantalum (Ta), molybdenum (Mo), and stainless steel (SUS)), a carbon material, or ceramics (for example Al2O3) is used as a material for the high-temperature body. The high-temperature body is preferably subjected to surface treatment or the like to enhance emissivity.

In addition, the high-temperature body is provided in a form of a plate, and is disposed in a position such that the high-temperature body is orthogonal to an outflow direction of vapor of the material from the material retaining part. It is thereby possible to reduce variations in thickness of an evaporated film formed on the evaporated member which variations result from bumping of the evaporating material, and further bring about an effect of helping diffusion of the vapor within the evaporation source. Further, in this case, a position for securing a sufficient flow path for the vapor of the material is selected so that an increase in material heating temperature for obtaining a desired rate can be suppressed.

According to another embodiment, there is provided an evaporating method for heating an evaporating material in a state of the evaporating material being filled in a material retaining part, vaporizing the evaporating material, and dispersing the vaporized evaporating material from an opening to an evaporated member, the evaporating method including disposing a high-temperature body between the material retaining part and the opening, and heating the high-temperature body to a temperature higher than a temperature of the evaporating material heated in the material retaining part when evaporation is performed.

According to an embodiment, only the surface of the material retaining part and the material filled in the material retaining part can be locally heated by radiant heat from the high-temperature body heated to the temperature higher than that of the material retaining part and the material at the time of evaporation. Thus a desired evaporation rate can be obtained without producing an effect of heating on the inside of the evaporating material.

According to another embodiment, there is provided an organic electroluminescent element having a first electrode, an organic layer including a light emitting layer, and a second electrode on a substrate, wherein the light emitting layer is formed by evaporation by an evaporating method for heating an organic material in a state of the organic material being filled in a material retaining part, vaporizing the organic material, and dispersing the vaporized organic material from an opening to the substrate, the evaporating method including disposing a high-temperature body between the material retaining part and the opening, and heating the high-temperature body to a temperature higher than a temperature of the organic material heated in the material retaining part.

According to another embodiment, there is provided a display device using an organic electroluminescent element, the organic electroluminescent element having a first electrode, an organic layer including a light emitting layer, and a second electrode on a substrate, wherein the light emitting layer is formed by evaporation by an evaporating method for heating an organic material in a state of the organic material being filled in a material retaining part, vaporizing the organic material, and dispersing the vaporized organic material from an opening to the substrate, the evaporating method including disposing a high-temperature body between the material retaining part and the opening, and heating the high-temperature body to a temperature higher than a temperature of the organic material heated in the material retaining part.

The heating of a surface layer by radiant heat from the high-temperature body can maintain the whole of the evaporating material filled in the material retaining part at a low average temperature, whereby degradation of the material can be suppressed. Thus, an element having good characteristics can be produced continuously over a long period of time. In addition, the distribution of thickness of an evaporated film formed on the evaporated member can be controlled stably for a long period of time over a wide area of the evaporated member.

Additional features and advantages are described herein, and will be apparent from, the following Detailed Description and the figures.

### BRIEF DESCRIPTION OF THE FIGURES

FIG. 1 is a schematic diagram of assistance in explaining an outline of an evaporating device according to an embodiment;

FIGS. 2A and 2B are schematic diagrams of assistance in explaining an example of device configuration of the evaporating device according to the present embodiment, FIG. 2A being a general view, and FIG. 2B being a partial enlarged view of a high-temperature body and the vicinity of the high-temperature body;

FIGS. 3A and 3B are schematic diagrams of assistance in explaining an example of configuration of an evaporating system to which the evaporating device according to the present embodiment is applied, FIG. 3A being a general view and FIG. 3B being a sectional view taken from a direction of the side of a pipe;

FIG. 4 is a schematic diagram of assistance in explaining how a material is reduced by evaporation;

FIGS. 5A and 5B are diagrams of assistance in explaining changes in evaporation rate with respect to the temperature of the high-temperature body, FIG. 5A corresponding to a case where the evaporation rate is a few angstroms/second, and FIG. 5B corresponding to a case where the evaporation rate is a few ten angstroms/second;

FIG. 6 is a diagram showing a result of simulation of in-plane distribution of evaporated film thickness, a solid line in FIG. 6 corresponding to a case of the evaporating device according to the present embodiment (with the high-temperature body), and a broken line in FIG. 6 corresponding to a case of an existing evaporating device (without the high-temperature body);

FIG. 7 is a schematic sectional view of assistance in explaining an example of an organic electroluminescent element formed by applying the evaporating device and an evaporating method according to the present embodiment;

FIGS. 8A and 8B are diagrams showing an example of a display device according to an embodiment, FIG. 8A being a schematic block diagram and FIG. 8B being a diagram of configuration of a pixel circuit;

FIG. 9 is a schematic plan view of assistance in explaining a module shape;

FIG. 10 is a perspective view of a television set to which the present embodiment is applied;

FIGS. 11A and 11B are perspective views of a digital camera to which the present embodiment is applied, FIG. 11A being a perspective view of the digital camera as viewed from a front side and FIG. 11B being a perspective view of the digital camera as viewed from a back side;

FIG. 12 is a perspective view of a notebook personal computer to which the present embodiment is applied;

FIG. 13 is a perspective view of a video camera to which the present embodiment is applied; and

FIGS. 14A, 14B, 14C, 14D, 14E, 14F, and 14G are diagrams showing a portable terminal device, for example a portable telephone to which the present embodiment is applied, FIG. 14A being a front view of the portable telephone in an opened state, FIG. 14B being a side view of the portable telephone in the opened state, FIG. 14C being a front view of the portable telephone in a closed state, FIG. 14D is a left side view, FIG. 14E being a right side view, FIG. 14F being a top view, and FIG. 14G being a bottom view.

### DETAILED DESCRIPTION

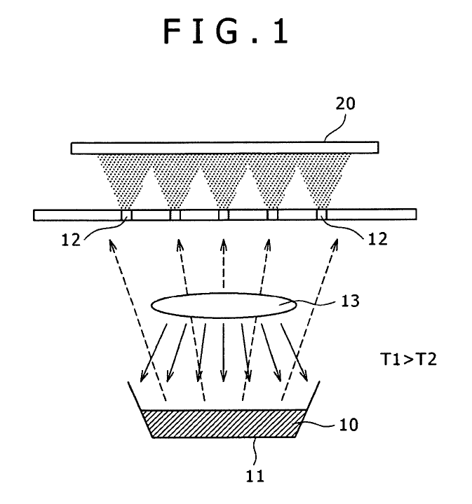

A preferred embodiment will hereinafter be described with reference to the drawings. FIG. 1 is a schematic diagram of assistance in explaining an outline of an evaporating device according to the present embodiment. Specifically, the evaporating device according to the present embodiment includes: a material retaining part 11 mainly using an organic material as an evaporating material 10, the material retaining part 11 being filled with the organic material as the evaporating material 10 and heating the organic material; openings 12 for dispersing the evaporating material 10 vaporized from the material retaining part 11 toward a substrate, for example, as an evaporated member 20; and a high-temperature body 13 disposed between the material retaining part 11 and the openings 12, the high-temperature body 13 being heated to a temperature T1 higher than a temperature T2 of the evaporating material 10 heated in the material retaining part 11.

The material retaining part 11 is heated by a heater not shown in the figure so as to be able to heat the whole of the evaporating material 10 housed inside the material retaining part 11 to a predetermined temperature T2. Usually this temperature T2 is set higher than the evaporating temperature of the evaporating material 10 to create a state in which the evaporating material 10 is dispersed toward the evaporated member 20. In the present embodiment, however, the temperature T2 is set lower than the evaporating temperature of the evaporating material 10. It is thereby possible to suppress characteristic degradation of the evaporating material 10, which is an organic material or the like, housed in the material retaining part 11. Incidentally, when a material whose characteristic degradation due to heating is noticeable other than the organic material is applied as the evaporating material 10, a similar effect of suppressing the characteristic degradation to that of the organic material can be obtained.

The high-temperature body 13 as a feature of the evaporating device according to the present embodiment is disposed between the evaporating material 10 in the material retaining part 11 and the openings 12, and is heated to the temperature T1 higher than the temperature T2 of the evaporating material 10. At this temperature T1, radiant heat from the high-temperature body 13 locally heats a part of a surface side of the evaporating material 10 within the material retaining part 11 to a temperature higher than the evaporating temperature. That is, the radiant heat from the high-temperature body 13 locally heats the part of the evaporating material 10, so that only the part reaches a temperature necessary for evaporation.

The high-temperature body 13 may be disposed at any position as long as the position enables a temperature difference to be intentionally provided between the inside and the surface of the evaporating material 10 filled in the material retaining part 11. Preferably, the high-temperature body 13 is disposed in the vicinity of the evaporating material 10 for higher efficiency of radiation. However, the high-temperature body 13 should not unnecessarily impede a flow of vapor of the evaporating material 10.

A material selected from a metallic material, a carbon material, and ceramics is used as a material for the high-temperature body 13. Of the materials, the metallic material includes for example titanium (Ti), tantalum (Ta), molybdenum (Mo), and stainless steel (SUS). The ceramics include Al2O3, for example. That is, a stable material that does not decompose or emit gas, for example, as a result of being heated in a vacuum is used as the high-temperature body 13. In addition, the high-temperature body 13 is preferably subjected to surface treatment or the like to enhance emissivity.

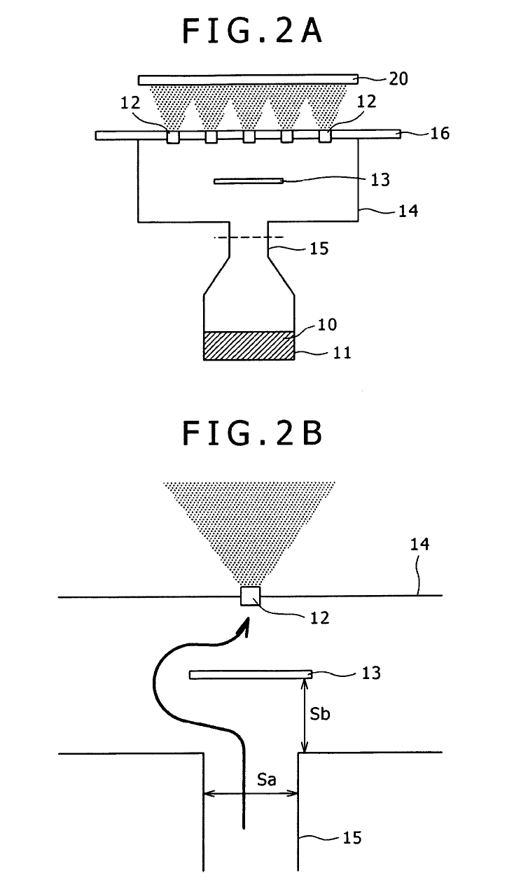

FIGS. 2A and 2B are schematic diagrams of assistance in explaining an example of device configuration of the evaporating device according to the present embodiment, FIG. 2A being a general view, and FIG. 2B being a partial enlarged view of the high-temperature body and the vicinity of the high-temperature body. In the device configuration shown in FIG. 2A, a plurality of openings 12 are arranged on the upper side of a pipe 14 along a direction of width of the evaporated member 20, and the high-temperature body 13 is attached to substantially the center of the inside of the pipe 14. Incidentally, a heat shield plate 16 for preventing the heat of the evaporation source from being transmitted to the evaporated member 20 is provided on an external surface on the evaporated member 20 side of the pipe 14.

A passage pipe 15 is provided on the lower side of the pipe 14. The pipe 14 and the material retaining part 11 are connected to each other via the passage pipe 15. The pipe 14 and the material retaining part 11 are each provided with a heater (not shown) controlled separately. A broken line in FIG. 2A is a thermal barrier. Control for providing a difference in temperature between the upper side and the lower side of this thermal barrier as a boundary is thus made possible.

By heating the pipe 14 with the heater, the high-temperature body 13 within the pipe 14 is also heated to the predetermined temperature T1 (see FIG. 1). Meanwhile, the material retaining part 11 is also heated, so that the evaporating material 10 within the material retaining part 11 is heated to the predetermined temperature T2 (see FIG. 1).

The high-temperature body 13 is provided in the form of a plate, and is disposed in a position such that the high-temperature body 13 is orthogonal to an outflow direction of vapor of the evaporating material 10 from the material retaining part 11. That is, the high-temperature body 13 is disposed in the form of a shield between the hole of the passage pipe 15 and the openings 12, thereby preventing the vapor of the evaporating material 10 from directly going from the passage pipe 15 to the openings 12. Such a disposition can reduce variations in thickness of an evaporated film formed on the evaporated member 20 which variations result from bumping when the organic material is vaporized, for example, and further provides an effect of helping diffusion of the vapor within the evaporation source.

As shown in FIG. 2B, in disposing the high-temperature body 13 in the form of shielding the outlet of the passage pipe 15, a sufficient flow path for the vapor of the evaporating material 10 needs to be secured. Letting Sa be a cross-sectional area of the outlet part of the passage pipe 15, and letting Sb be a cross-sectional area between the lower side (the passage pipe 15 side) of the high-temperature body 13 and the inner wall of the pipe 14, the diameter of the pipe and the position of the high-temperature body 13 are selected such that Sa<Sb.

Specifically, by sufficiently lowering a conductance in a flow of vapor around the high-temperature body 13 with respect to a conductance in a flow of vapor in the passage pipe 15, even when there is a shield formed by the high-temperature body 13, it is possible to suppress an increase in material heating temperature for obtaining a desired rate.

In order to perform evaporation using such an evaporating device, an organic material or the like as the evaporating material 10 is housed in the material retaining part 11, and the material retaining part 11 is attached to the passage pipe 15. The material retaining part 11 is attached to the passage pipe 15 via a gasket, and the material retaining part 11 and the passage pipe 15 are detachably fixed to each other by a damper mechanism.

Next, the material retaining part 11 is heated by a heater, and the pipe 14 is heated by a heater. At this time, as a temperature control by the heater, the material retaining part 11 side is controlled to be at the temperature T2 lower than the evaporating temperature of the evaporating material 10. Meanwhile, the pipe 14 side is controlled such that the high-temperature body 13 disposed within the pipe 14 is at the temperature T1 higher than the temperature T2.

When the high-temperature body 13 reaches the temperature T1, radiant heat from the high-temperature body 13 is transmitted from the passage pipe 15 to the surface of the evaporating material 10 in the material retaining part 11, so that local heating is performed. A vapor of the evaporating material 10 is produced in a stage where the surface of the evaporating material 10 exceeds the evaporating temperature.

The vapor of the evaporating material 10 flows into the pipe 14 from the passage pipe 15, goes round the high-temperature body 13 so as to avoid the high-temperature body 13, and is dispersed from the openings 12 provided on the upper side of the pipe 14 toward the evaporated member 20. The dispersed vapor of the evaporating material 10 is deposited on the evaporated member 20 and then cooled. The vapor of the evaporating material 10 is thereby formed as an evaporated film.

Incidentally, the evaporating device according to the present embodiment can control an evaporation rate by fixing the heating temperature for heating the evaporating material 10 by the material retaining part 11 and controlling the heating temperature for heating the high-temperature body 13. That is, the evaporation rate is increased as the temperature of the high-temperature body 13 becomes higher, and the evaporation rate is decreased as the temperature of the high-temperature body 13 becomes lower.

In the case where the evaporation rate is adjusted by such control of the temperature of the high-temperature body 13, by controlling the temperature on the material retaining part 11 side such that the temperature of the evaporating material 10 is constant, it is possible to prevent a load imposed by heat on the evaporating material 10 within the material retaining part 11 and suppress characteristic degradation even when continuous evaporating operation is performed over a long period of time.

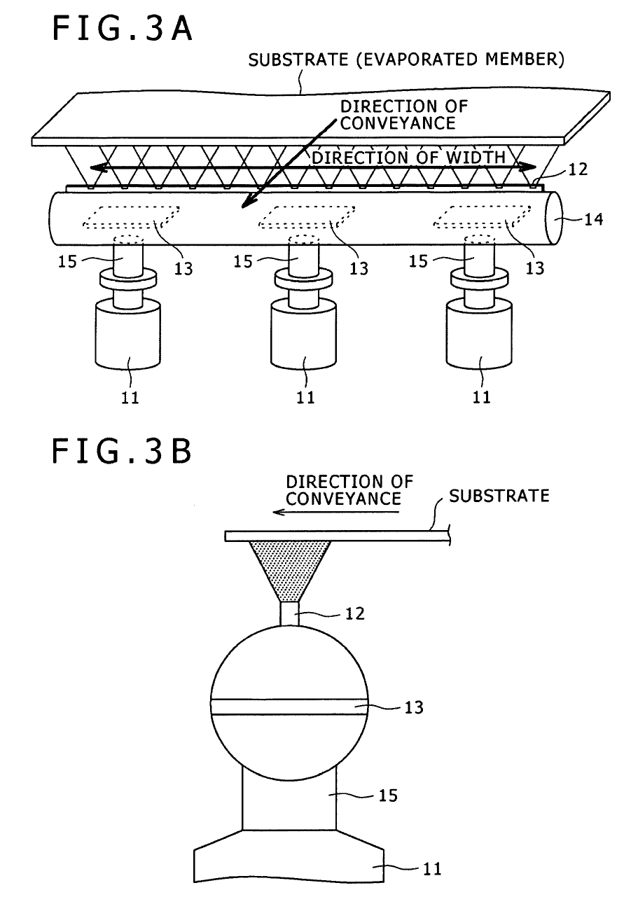

FIGS. 3A and 3B are schematic diagrams of assistance in explaining an example of configuration of an evaporating system to which the evaporating device according to the present embodiment is applied, FIG. 3A being a general view and FIG. 3B being a sectional view taken from a direction of the side of the pipe 14. In this evaporating system, three evaporation sources are attached to the pipe 14. A substrate (evaporated member) disposed on the upper side of the pipe 14 is moved relative to the evaporation sources, whereby an evaporated film is formed on the lower surface of the substrate.

Thus, the pipe 14 is extended in a direction orthogonal to a direction of conveyance of the substrate (evaporated member) passing the upper side of the pipe 14, and the respective evaporation sources are arranged at the central part and both end parts of the pipe 14. Thereby the evaporated film can be formed uniformly along a direction of width of the substrate.

Each evaporation source includes: a material retaining part 11 for housing and heating an evaporating material as described earlier: a passage pipe 15 for connecting the material retaining part 11 to the pipe 14; and a high-temperature body 13 disposed between the outlet of the passage pipe 15 and openings 12. These sets are arranged in correspondence with the respective evaporation sources.

When a plurality of high-temperature bodies 13 corresponding to a plurality of evaporation sources are arranged within one pipe 14, predetermined intervals are provided between the high-temperature bodies 13. Thereby a flow path for the vapor of the evaporating material within the pipe 14 is secured.

As shown in FIG. 3B, the high-temperature body 13 is disposed in a state of straddling the inside diameter of the pipe 14, and can be fixed at a position within the pipe 14. For example, slits are provided in the pipe 14 at positions straddled by the high-temperature body 13, the high-temperature body 13 is inserted from the slits and fitted into the slits so as to straddle the inside of the pipe 14, and then slit parts where the high-temperature body 13 and the pipe 14 intersect each other are welded, whereby the high-temperature body 13 is fixed.

The evaporation sources of the respective sets including such a high-temperature body 13 and the material retaining part 11 may be subjected to same temperature control or may be each subjected to different temperature control. By setting conditions, uniform evaporation is possible even under the same temperature control. In this case, a system configuration can be simplified with one temperature control system for the side of the pipe 14 and one temperature control system for the side of the material retaining parts 11.

On the other hand, by providing a temperature control system separately for each high-temperature body 13 and each material retaining part 11 in each evaporation source, the evaporation rate of each evaporation source can be controlled minutely by temperature management according to a result of detection of the evaporation rates at different positions.

Further, because the temperature of the evaporating material in the material retaining parts 11 can be made constant, the temperature control system for each material retaining part 11 in each evaporation source may be integrated into one temperature control system, and an individual temperature control system may be provided for each high-temperature body 13 in each evaporation source. It is thereby possible to make a simple system configuration on the side of the material retaining parts 11, and minutely control the evaporation rate of each evaporation source by individual control of the temperature of each high-temperature body 13.

In performing evaporation onto a substrate by such an evaporating system, the substrate is passed over the openings 12 of the pipe 14 with an evaporating material housed in each material retaining part 11 of each evaporation source and with the material retaining parts 11 and the high-temperature bodies 13 each heated to predetermined temperatures by control of the temperature of the material retaining parts 11 and the high-temperature bodies 13 as described above. Thereby a uniform evaporated film can be formed on even a wide substrate, for example.

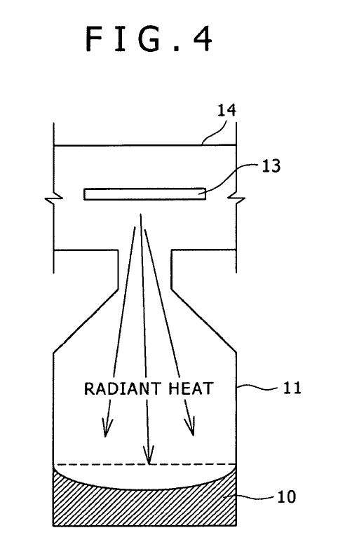

FIG. 4 is a schematic diagram of assistance in explaining how the material is reduced by evaporation. Specifically, in the evaporating device having the high-temperature body 13 disposed within the pipe 14 as in the present embodiment, radiant heat from the high-temperature body 13 locally heats the evaporating material 10 within the material retaining part 11. Therefore the central part of the surface of the evaporating material 10 vaporizes first even when the material retaining part 11 is heated from the outside.

In the example of FIG. 4, the position of the surface of the evaporating material 10 when the evaporating material 10 has been placed in the material retaining part 11 is indicated by a broken line in FIG. 4, and is a substantially flat position. The evaporating material 10 is reduced such that the central part of the surface of the evaporating material 10 becomes hollow. It is thus shown that vaporization occurs efficiently due to an effect of the radiant heat generated by the high-temperature body 13.

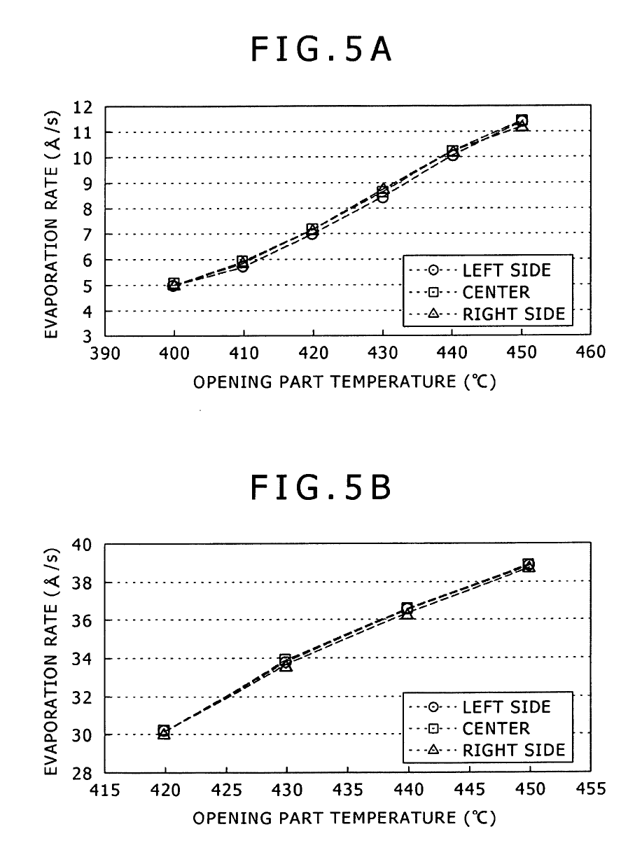

FIGS. 5A and 5B are diagrams of assistance in explaining changes in evaporation rate with respect to the temperature of the high-temperature body, FIG. 5A corresponding to a case where the evaporation rate is a few angstroms/second, and FIG. 5B corresponding to a case where the evaporation rate is a few ten angstroms/second. Three lines in each figure correspond to different evaporating positions (the central part, the right side, and the left side) of the evaporated member.

Incidentally, in each of FIGS. 5A and 5B, the temperature of the material retaining part is fixed, and only the temperature of the high-temperature body is changed.

These graphs show that the evaporation rate is increased as the temperature of the high-temperature body becomes higher with the temperature of the material retaining part fixed. Thus the evaporation rate proportional to the temperature of the high-temperature body can be obtained by radiant heat generated by disposing the high-temperature body as a feature part of the evaporating device according to the present embodiment within the pipe and heating the high-temperature body.

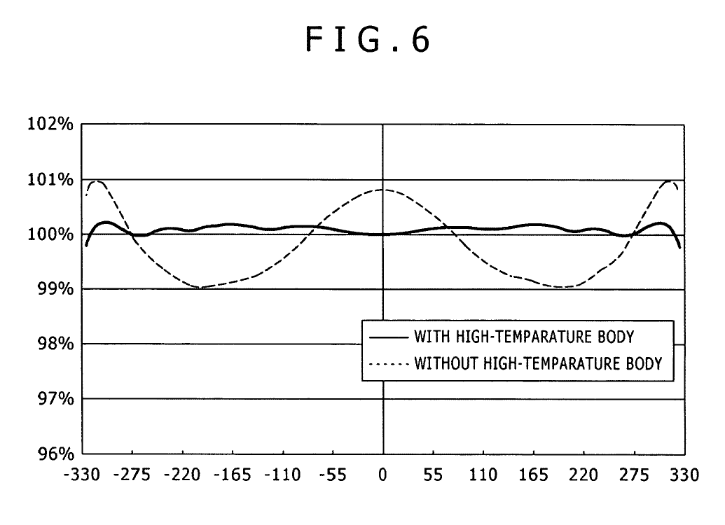

FIG. 6 is a diagram showing a result of simulation of in-plane distribution of evaporated film thickness. A solid line in FIG. 6 corresponds to the case of the evaporating device according to the present embodiment (with the high-temperature body). A broken line in FIG. 6 corresponds to the case of an existing evaporating device (without the high-temperature body). An axis of abscissas in FIG. 6 indicates the in-plane position of the evaporated member. An axis of ordinates in FIG. 6 indicates film thickness (a target film thickness being 100%).

It is shown that in the case of the existing evaporating device (without the high-temperature body) indicated by the broken line in FIG. 6, the distribution is greatly varied in in-plane film thickness, whereas in the case of the evaporating device according to the present embodiment (with the high-temperature body), there are small variations with respect to the target film thickness and thus film thickness of excellent uniformity can be obtained.

Description will next be made of an organic electroluminescent element formed by using the evaporating device and the evaporating method described above, display devices using the organic electroluminescent element, and examples of application.

(Organic Electroluminescent Element)

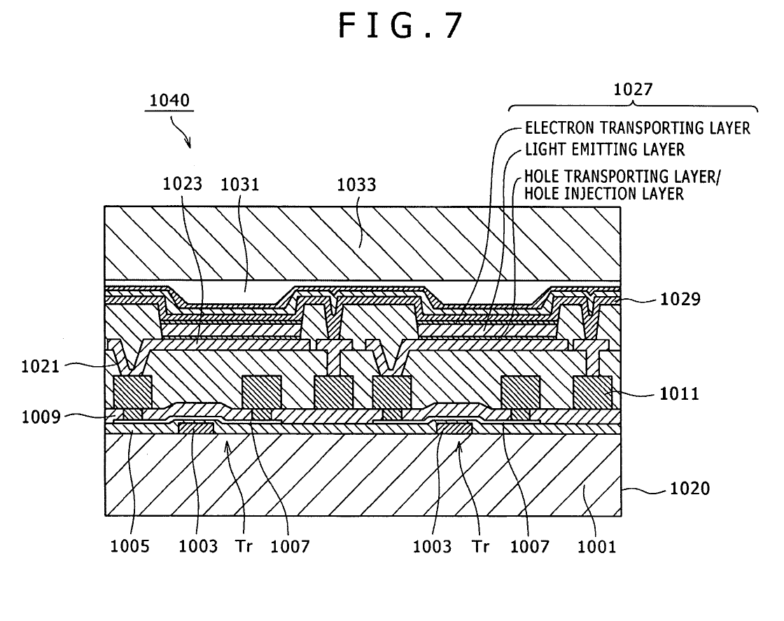

FIG. 7 is a schematic sectional view of assistance in explaining an example of an organic electroluminescent element formed by applying the evaporating device and the evaporating method according to the present embodiment. In the organic electroluminescent element, a thin-film transistor Tr is formed by laminating a gate electrode 1003, a gate insulating film 1005, and a semiconductor layer 1007 in order on a glass substrate 1001. The thin-film transistor Tr is covered by an interlayer insulating film 1009. Wiring 1011 connected to the thin-film transistor Tr is provided via connecting holes formed in the interlayer insulating film 1009 to form a pixel circuit. Thus a so-called TFT substrate 1020 is formed.

The top surface of the TFT substrate 1020 is covered by a planarizing insulating film 1021. Connecting holes reaching the wiring 1011 are formed in the planarizing insulating film 1021. A pixel electrode (first electrode) 1023 connected to the wiring 1011 via the connecting holes is formed as an anode, for example, on the planarizing insulating film 1021. An insulating film pattern 1025 in such a shape as to cover the periphery of the pixel electrode 1023 is formed.

An organic EL material layer 1027 is formed as a laminated film in a state of covering an exposed surface of the pixel electrode 1023. A counter electrode (second electrode) 1029 is formed in a state in which insulation from the pixel electrode 1023 is maintained by the insulative pattern 1025 and the organic EL material layer 1027. This counter electrode 1029 is formed as a cathode made of a transparent conductive material, for example, and is formed in the shape of a solid film common to all pixels.

Thereafter a transparent substrate 1033 is laminated over the counter electrode 1029 via an adhesive layer 1031 having optical transparency, whereby an organic electroluminescent element 1040 is completed.

In the present embodiment, the evaporating device and the evaporating method described earlier are applied to the formation of the above-described organic EL material layer 1027. It is thereby possible to form a uniform film without characteristic degradation of the materials even when continuous evaporation is performed over a long period of time, and thus improve the light emitting characteristic of the organic electroluminescent element.

(Display Device)

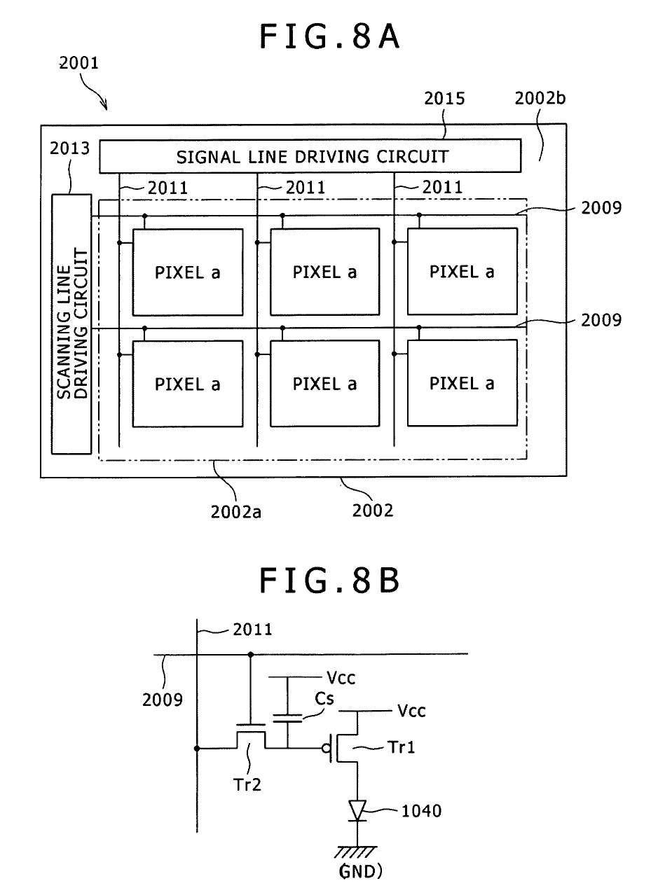

FIGS. 8A and 8B are diagrams showing an example of a display device according to an embodiment, FIG. 8A being a schematic block diagram and FIG. 8B being a diagram of configuration of a pixel circuit. Description in the following will be made of an embodiment in which the present application is applied to an active matrix type display device using the organic electroluminescent element 1040 as a light emitting element.

As shown in FIG. 8A, a display area 2002a and a peripheral area 2002b around the periphery of the display area 2002a are set on a substrate 2002 of the display device 2001. The display area 2002a is formed as a pixel array unit in which a plurality of scanning lines 2009 and a plurality of signal lines 2011 are arranged vertically and horizontally and one pixel a is provided in correspondence with each of intersection parts of the plurality of scanning lines 2009 and the plurality of signal lines 2011. An organic electroluminescent element is provided in each of these pixels a.

The peripheral area 2002b includes a scanning line driving circuit 2013 for scanning and driving the scanning lines 2009 and a signal line driving circuit 2015 for supplying a video signal (that is, an input signal) corresponding to luminance information to the signal lines 2011.

As shown in FIG. 8B, a pixel circuit provided in each pixel a includes for example an organic electroluminescent element 1040, a driving transistor Tr1, a writing transistor (sampling transistor) Tr2, and a storage capacitor Cs.

The storage capacitor Cs retains the video signal written from a signal line 2011 via the writing transistor Tr2 by driving by the scanning line driving circuit 2013. A current corresponding to the amount of the retained signal is supplied from the driving transistor Tr1 to the organic electroluminescent element 1040. The organic electroluminescent element 1040 emits light at a luminance corresponding to the value of the current.

it is to be noted that the configuration of the pixel circuit as described above is a mere example. As required, a capacitive element may be provided within the pixel circuit, and a plurality of transistors may be further provided to form the pixel circuit. In addition, a driving circuit that may be required according to a change in the pixel circuit is added to the peripheral area 2002b.

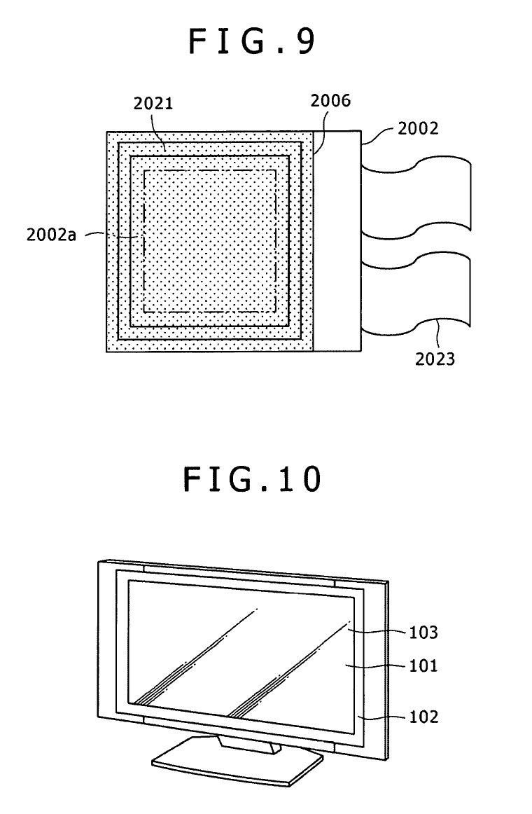

The display device 2001 according to the present embodiment also includes a display device in the form of a module having a sealed constitution as disclosed in FIG. 9. For example, a display module corresponds to the display device 2001 which display module is formed by providing a sealing part 2021 in such a manner as to surround a display area A as a pixel array unit and laminating the pixel array unit to a counter part (a sealing substrate 2006 (corresponding to the sealing substrate 1033 in FIG. 7)) such as a transparent glass or the like with the sealing part 2021 serving as an adhesive.

The transparent sealing substrate 2006 may include a color filter, a protective film, a light shielding film, and the like. Incidentally, a flexible printed board 2023 for externally inputting a signal or the like to the display area 2002a (pixel array unit) may be provided to the substrate 2002 of the display module in which the display area A is formed.

### EXAMPLES OF APPLICATION

The display device according to the present embodiment described above is applicable to display units of electronic devices in all fields which display units display a video signal input to an electronic device or a video signal generated within an electronic device as an image or video, the electronic devices including various electronic devices shown in FIGS. 10 to 14, for example a digital camera, a notebook personal computer, a portable terminal device such as a portable telephone or the like, and a video camera. An example of an electronic device to which the present embodiment is applied will be described below.

FIG. 10 is a perspective view of a television set to which the present embodiment is applied. The television set according to the present example of application includes a video display screen unit 101 formed by a front panel 102, a filter glass 103 and the like. The television set is fabricated using the display device according to the present embodiment as the video display screen unit 101.

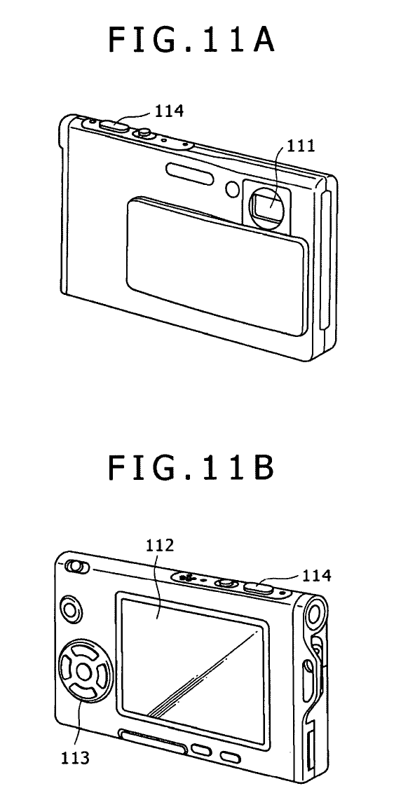

FIGS. 11A and 11B are perspective views of a digital camera to which the present embodiment is applied, FIG. 11A being a perspective view of the digital camera as viewed from a front side and FIG. 11B being a perspective view of the digital camera as viewed from a back side. The digital camera according to the present example of application includes a light emitting unit 111 for a flash, a display unit 112, a menu switch 113, a shutter button 114 and the like. The digital camera is fabricated using the display device according to the present embodiment as the display unit 112.

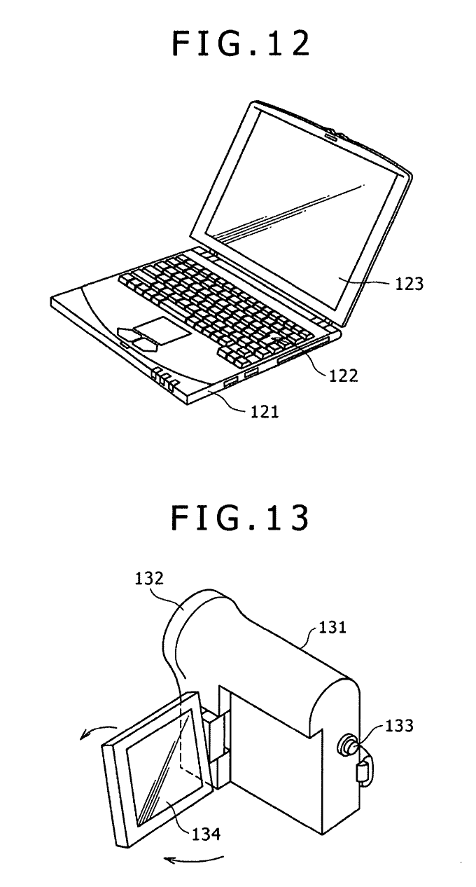

FIG. 12 is a perspective view of a notebook personal computer to which the present embodiment is applied. The notebook personal computer according to the present example of application includes a keyboard 122 operated to input characters and the like, a display unit 123 for displaying an image, and the like in a main unit 121. The notebook personal computer is fabricated using the display device according to the present embodiment as the display unit 123.

FIG. 13 is a perspective view of a video camera to which the present embodiment is applied. The video camera according to the present example of application includes a main unit 131, a lens 132 for taking a picture of a subject, which lens is situated on a side facing frontward, a start/stop switch 133 at the time of taking the picture, a display unit 134, and the like. The video camera is fabricated using the display device according to the present embodiment as the display unit 134.

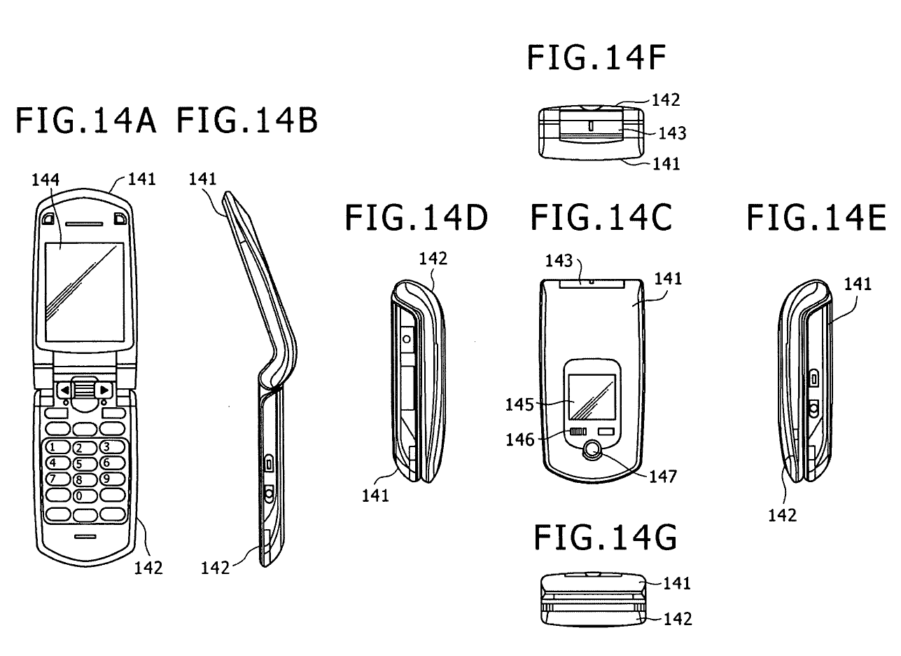

FIGS. 14A to 14G are diagrams showing a portable terminal device, for example a portable telephone to which the present embodiment is applied, FIG. 14A being a front view of the portable telephone in an opened state, FIG. 14B being a side view of the portable telephone in the opened state, FIG. 14C being a front view of the portable telephone in a closed state, FIG. 14D is a left side view, FIG. 14E being a right side view, FIG. 14F being a top view, and FIG. 14G being a bottom view. The portable telephone according to the present example of application includes an upper side casing 141, a lower side casing 142, a coupling part (a hinge part in this case) 143, a display 144, a sub-display 145, a picture light 146, a camera 147 and the like. The portable telephone is fabricated using the display device according to the present embodiment as the display 144 and the sub-display 145.

It is to be noted that the display device according to the present embodiment is applicable to products other than the above-described examples of application, and that the evaporated film formed by the evaporating method according to the present embodiment is applicable to other than the organic EL material layer.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An evaporating device comprising:
a material retaining part for being filled with an evaporating material and heating the evaporating material;
an opening for dispersing said evaporating material vaporized from said material retaining part toward an evaporated member; and
a high-temperature body disposed between said material retaining part and said opening, the high-temperature body being heated to a temperature higher than a temperature of said evaporating material heated in said material retaining part.

2. The evaporating device according to claim 1, wherein a surface part of said evaporating material filled in said material retaining part is locally heated by radiant heat from said high-temperature body.

3. The evaporating device according to claim 1, wherein said high-temperature body is formed in a plate shape, and a plate surface of said plate shape is disposed in a direction orthogonal to an outflow direction of vapor of said evaporating material from said material retaining part.

4. The evaporating device according to claim 1,
wherein a selected one of a metallic material, a carbon material, and ceramics is used as said high-temperature body.

5. The evaporating device according to claim 1, wherein said evaporating material is an organic material.

6. An evaporating method for heating an evaporating material in a state of said evaporating material being filled in a material retaining part, vaporizing said evaporating material, and dispersing the vaporized said evaporating material from an opening to an evaporated member, said evaporating method comprising the steps of:
disposing a high-temperature body between said material retaining part and said opening; and
heating said high-temperature body to a temperature higher than a temperature of said evaporating material heated in said material retaining part when evaporation is performed.

7. An organic electroluminescent element having a first electrode, an organic layer including a light emitting layer, and a second electrode on a substrate,
wherein said light emitting layer is formed by evaporation by an evaporating method for heating an organic material in a state of said organic material being filled in a material retaining part, vaporizing said organic material, and dispersing the vaporized said organic material from an opening to said substrate, the evaporating method including disposing a high-temperature body between said material retaining part and said opening, and heating said high-temperature body to a temperature higher than a temperature of said organic material heated in said material retaining part.

8. A display device using an organic electroluminescent element, the organic electroluminescent element having a first electrode, an organic layer including a light emitting layer, and a second electrode on a substrate,
wherein said light emitting layer is formed by evaporation by an evaporating method for heating an organic material in a state of said organic material being filled in a material retaining part, vaporizing said organic material, and dispersing the vaporized said organic material from an opening to said substrate, the evaporating method including disposing a high-temperature body between said material retaining part and said opening, and heating said high-temperature body to a temperature higher than a temperature of said organic material heated in said material retaining part.

9. A method for manufacturing a display device, said method including an evaporating step of heating an evaporating material in a state of said evaporating material being filled in a material retaining part, vaporizing said evaporating material, and dispersing the vaporized said evaporating material from an opening to an evaporated member,
wherein a high-temperature body is disposed between said material retaining part and said opening, and said high-temperature body is heated to a temperature higher than a temperature of said evaporating material heated in said material retaining part when evaporation is performed.
